(19) United States
(12) Patent Application Publication
(10) Pub. No.: US 2025/0019164 A1
(43) Pub. Date: Jan. 16, 2025

(54) A SERVICE VEHICLE FOR AN AUTOMATED STORAGE AND RETRIEVAL SYSTEM

(71) Applicant: Autostore Technology AS, Nedre Vats (NO)

(72) Inventors: Trond Austrheim, Etne (NO); Ingvar Fagerland, Kolnes (NO)

(73) Assignee: Autostore Technology AS, Nedre Vats (NO)

(21) Appl. No.: 18/701,868

(22) PCT Filed: Oct. 17, 2022
(86) PCT No.: PCT/EP2022/078799

§ 371 Date: Apr. 16, 2024

(30) Foreign Application Priority Data
Oct. 18, 2021 (NO) 20211250

(51) Int. Cl. B65G 1/04; A01G 9/14; A01G 9/24

(52) U.S. Cl. CPC B65G 1/0464; A01G 9/143; A01G 9/247; B65G 2201/0202

(57) ABSTRACT

An automated storage and retrieval system includes a plurality of goods holders for holding crops, and a storage section configured for storing goods holders in a plurality of columns. A service vehicle for irrigation and/or inspection of crops stored within the automated storage and retrieval system is movable above the storage section and includes irrigation equipment for irrigating crops held by a goods holder, and/or inspection equipment for inspecting crops held by a goods holder.

### FIELD OF THE INVENTION

The present invention relates to an automated storage and retrieval system for storage and retrieval of containers, and in particular to a service vehicle for such a system being used for vertical farming.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Vertical farming is the practice of growing crops in vertically stacked layers. For this purpose, an automated storage and retrieval systems may be used to reduce the human labour. However, compared to most other types of storage items, crops have a higher maintenance requirement.

In a typical automated storage and retrieval system, storage containers holding crops may periodically be retrieved for maintenance such as inspection, irrigation, weeding, thinning, fertilizing, pest control, harvesting, etc. The storage containers may then be retrieved from their respective storage space and brought to an inspection station where maintenance is performed. After maintenance, the storage containers may be returned to their previous storage space or another storage space as appropriate.

A vertical farming system comprising a growth monitoring station is proposed in EP3326452, where it is disclosed an illuminated cultivation storage system and a method for cultivating crops in an illuminated cultivation storage system. The system comprises a three-dimensional framework structure forming a grid of vertical and horizontal storage tunnels, a plurality of storage containers for holding growing crops. The storage containers being configured to be introduced into the framework structure. The system further has a plurality of lighting devices, a transport system, and an illumination controller. Further, the interior of the framework structure exhibits distinguishable climate zones, each climate zone having a set of growth parameters including temperature. The system further comprises a growth monitoring station which includes sensors for determining a current growth status of crops and a growth controller connected to the transport system and being configured to operate the transport system in order to return storage containers to a designated climate zone based on the determined growth status.

Periodical maintenance of the crops held by the storage containers thus requires the storage containers to be repeatedly stored and retrieved, which is at the expense of the overall storage container handling capacity of the system.

EP3282830A1 discloses a growing system where plants are grown in containers and the containers are stored in stacks. Above the stacks runs a grid network of tracks on which load handling devices run. The load handling devices take containers from the stacks and deposit then at alternative locations in the stacks or deposit them at stations where goods may be picked out. The containers may be provided with one or more of the following services: power, power control, heating, lighting, cooling, sensing means, data logging means, growing means, water and nutrients.

By providing water to each storage container at their storage space, the intervals at which storage containers holding crops must be retrieved for maintenance may be increased. However, that requires a comprehensive pipe infrastructure within the storage system.

It is an objective of the present invention to at least to some extent reduce drawbacks of the prior art vertical farming systems.

### SUMMARY OF THE INVENTION

The present invention is set forth and characterized in the independent claims, while the dependent claims describe other characteristics of the invention.

The present invention relates to a service vehicle for irrigation and/or inspection of crops stored within an automated storage and retrieval system, wherein the automated storage and retrieval system comprises:
a plurality of goods holders for holding crops,
a storage section configured for storing goods holders in a plurality of columns,
   wherein the service vehicle is movable above the storage section and comprises:
irrigation equipment for irrigating crops held by a goods holder, and/or
inspection equipment for inspecting crops held by a goods holder.

An advantage of the service vehicle is that the transport distance can be reduced when goods holders are retrieved for irrigation and/or inspection.

In one aspect, the service vehicle may comprise:
a yoke configured for holding irrigation and/or inspection equipment.

In one aspect, the service vehicle may comprise:
a reel configured for lowering and raising the yoke into and out of the storage section

such that the yoke can reach goods holders stored in the automated storage and retrieval system.

An advantage of the service vehicle is that crops can be irrigated and/or inspected while being stored in the automated storage and retrieval system, i.e. the goods holders does not need to be retrieved from their storage spaces for irrigation and/or inspection.

An advantage of the service vehicle is that it can operate on existing storage and retrieval systems without requiring modifications of the storage and retrieval system.

The goods holder may e.g. be a storage container, a bin, a tote, a pallet, a tray or similar. Different types of goods holders may be used in the same system.

The storage section may comprise upright members and a storage volume comprising storage columns arranged in rows between the upright members. In these storage columns goods holders, such as storage containers, can be stacked one on top of one another to form stacks. The members may typically be made of metal, e.g. extruded aluminium profiles.

The storage section may comprise a plurality of goods holder supporting frameworks arranged beneath each other and extending parallel to each other. The plurality of goods holder supporting frameworks may comprise a plurality of goods holder supports arranged in parallel along a first direction X. Each goods holder support may display at least one hole with an opening size being at least a maximum horizontal cross section of the goods holder to be stored. The hole(s) of the goods holder supporting frameworks may be vertically aligned and the plurality of goods holder supports of the goods holder supporting frameworks may be displaceable along a second direction Y orthogonal to the first direction X.

The service vehicle may communicate with a control system of the automated storage and retrieval system, typically by means of a wireless connection. The control system may thus operate the service vehicle, i.e. control movement of the service vehicle and control raising/lowering of the yoke.

The service vehicle may comprise a vehicle body, wherein the reel may be arranged on the vehicle body.

The reel may typically comprise a drum and a line coiled onto the drum.

The service vehicle may comprise a frame configured for arrangement on the vehicle body or be made as part of the vehicle body. The frame may be configured for holding the reel in a rotating manner.

The reel is preferably arranged such that one or several lines of the reel can be raised and lowered without interfering with the vehicle body.

The frame may comprise a cantilever part extending beyond the footprint of the vehicle body and arranged below the reel. The cantilever part may have an opening configured for receiving the yoke and keeping the yoke steady when the service vehicle is moving. The yoke can then be lowered into the storage section immediately after the service vehicle has come to a standstill, as the cantilever part of the frame will prevent the yoke from swinging.

The reel may further comprise a motor configured to apply rotational drive to the drum, thus raising or lowering the yoke.

In one aspect, the irrigation equipment may comprise:
a water tank, and
a nozzle arranged in fluid communication with the water tank.

As part of the irrigation process, the nozzle may be operated to supply water from the water tank to a goods holder stored in the automated storage and retrieval system. The nozzle can enable supply of a precise amount of water during irrigation. The nozzle may also provide a sprinkling effect that can be beneficial for certain types of crops.

The nozzle and the water tank may be connected by means of a hose.

The irrigation equipment may comprise a dispenser. The dispenser may e.g. dispense fertilizer.

Alternatively, fertilizer may be diluted in the water tank.

A pump may be arranged to supply water from the water tank.

The water tank may be arranged on the vehicle body. The water tank arranged on the vehicle body may have a capacity of at least 30 litres, preferably at least 50 litres even more preferred at least 100 litres.

The water tank may be arranged to counterbalance the reel and the yoke.

The water tank may be formed to encircle the reel at least partly.

The water tank may be of any shape, but in most cases, it is made of sections of cones, cylinders, cubes, or spheres.

The frame may be configured to encircle the water tank at least partly.

The water tank may be arranged on the yoke. The water tank arranged on the yoke may have a capacity of 10-30 litres.

If the water tank is arranged on the yoke, the nozzle may be arranged directly on the water tank.

In one aspect, the service vehicle may comprise a plurality of water tanks.

The service vehicle may comprise a water tank arranged on the vehicle body and an additional water tank arranged on the yoke. The water tank arranged on the yoke may have less capacity than the water tank arranged on the vehicle body. The water tank arranged on the vehicle body may be configured to refill the water tank arranged on the yoke when the yoke is raised above the storage section.

If the service vehicle comprises a water tank arranged on the yoke, the line(s) connecting the yoke to the reel may be a wire.

If the service vehicle comprises a water tank arranged on the yoke, the service vehicle may instead of the reel comprise a lifting device as disclosed e.g. in WO2015/193278A1 or NO317366.

In one aspect, the inspection equipment may comprise a camera.

As part of the inspection process, the camera may be used to inspect the condition of the crops held by the goods holders stored in the automated storage and retrieval system. Information obtained by means of the camera may be used to determine the condition of the crops and thus form basis for the irrigation process, i.e. if irrigation is required or not. Irrigation may follow fixed intervals regardless of the crops' condition or be based on the determined condition of the crops.

The camera may have an internal and/or an external battery. The camera may be connected to the external battery by means of a cable.

The inspection equipment may comprise a light source.

The inspection equipment may comprise one or several sensors.

The inspection equipment may comprise a sampling unit.

The yoke may comprise a gripping device for gripping goods holders. By grabbing a goods holder by means of the gripping device, the goods holder can be vertically transported with the yoke. Providing a gripping device on the yoke may be advantageous if the storage section has a configuration that may require so-called digging.

In one aspect, the reel may comprise one or several lines, such as a hose, a band, a cable, a wire, an umbilical or any combinations thereof.

If the water tank is arranged on the vehicle body of the service vehicle, the nozzle may be connected to the water tank by means of a hose arranged on the reel.

If the camera has an external battery arranged on a base of the service vehicle, the camera may be connected to the external battery by means of the cable arranged on the reel. The cable arranged on the reel may also be used for transferring signals.

A wire may be used for raising and lowering the yoke. However, if the reel comprises a hose, the hose may be configured for raising and lowering the yoke in addition to transferring fluid. And if the reel comprises a cable, the cable may be configured for raising and lowering the yoke in addition to transferring signals and/or power.

At least one hose, one cable, one wire, or any combinations thereof may be combined in an umbilical.

The reel may be configured for coiling more than one line (e.g. hose, cable, wire, band, or umbilical). These lines may be connected to the same yoke.

By connecting several lines to the same yoke, the stability of the yoke can be increased. The yoke may e.g. comprise two lines connected to the yoke.

By spacing the lines apart on the reel, the connection points on the yoke will also be spaced apart. This may further improve the stability of the yoke, both when being operated alone and when carrying a goods holder.

The service vehicle may comprise more than one reel. The plurality of reels may be configured for lowering and raising the same yoke or a plurality of yokes. As an example, two reels each comprising one line can be arranged and spaced apart on the same service vehicle, wherein the two lines may be connected to the same yoke.

In one aspect, the yoke may comprise a guiding device configured for guiding the yoke in the storage section.

The guiding device may prevent jamming of the yoke within the storage section. The guide device may also aid the yoke entering the storage section.

The guide device may also aid the yoke entering the cantilever part of the frame.

The guiding device may comprise vertically extending guide pins or guide plates arranged in corners of the yoke or along the periphery of the yoke.

In one aspect, the service vehicle may comprise a first set of wheels and a second set of wheels for moving the service vehicle along a rail system arranged above the storage section of the automated storage and retrieval system.

The first set of wheels may be arranged on opposite sides of a vehicle body of the service vehicle and configured to move the service vehicle along a first horizontal direction X on the rail system.

The second set of wheels may be arranged on other opposite sides of the vehicle body of the service vehicle and configured to move the service vehicle along a second horizontal direction Y perpendicular to the first direction X.

As an alternative, the service vehicle may comprise belts configured for driving on the rail system. The service vehicle may alternatively be arranged on an overhead crane e.g. if the automated storage and retrieval system does not comprise a rail system.

The first and second sets of rails may form a grid pattern in the horizontal plane comprising a plurality of adjacent cells, each comprising an access opening defined by a pair of neighbouring rails of the first set of rails and a pair of neighbouring rails of the second set of rails. The area of the yoke may then have a size allowing it to enter the access openings of the rail system.

The vehicle body may have a footprint corresponding to one or several cells of the rail system.

In one aspect, the service vehicle may comprise a plurality of vehicle bodies, typically arranged side-by-side, or alternatively spaced apart. One water tank may be arranged on more than one vehicle body. The number of vehicle bodies may depend on the size of the water tank.

A service vehicle comprising several vehicle bodies may be able to better distribute the weight of the water tank, i.e. distribute the weight on a larger area.

A service vehicle comprising several vehicle bodies will typically have a greater number of wheels in one or both of the first set of wheels and the second set of wheels. A greater number of wheels may also contribute in distributing the weight of the service vehicle.

When the service vehicle is changing its direction of travel from the X direction to the Y direction, or vice versa, one of the sets of wheels is engaged with the rail system and the other set of wheels is disengaged from the rail system. This is typically performed by a mechanism lowering/raising one of the sets of wheels. A service vehicle comprising several vehicle bodies may be provided with a plurality of such mechanisms. As a result, the service vehicle may have an increased capacity to lower/raise the set of wheels, which in turn may allow it to carry a bigger water tank.

It is also possible that the service vehicle comprises one enlarged vehicle body providing the above-mentioned advantages of several vehicle bodies.

In one aspect, the service vehicle may comprise a main vehicle body and an auxiliary vehicle body being detachable from the main vehicle body. Wherein the reel, the irrigation equipment and the yoke are arranged on the main vehicle body, and the water tank is arranged on the auxiliary vehicle body. Wherein the water tank of the auxiliary vehicle body is connectable to the irrigation equipment of the main vehicle body. When the water tank of the auxiliary vehicle body is empty, the auxiliary vehicle body may be detached from the main vehicle body and refilled, e.g. at a refill station. In the meantime, a second auxiliary vehicle body with a full water tank can be connected to the main vehicle body. A water tank may also be arranged on the main vehicle body. By using auxiliary vehicle bodies, the size of the water tank arranged on the main vehicle body can be reduced or removed.

The present invention also relates to an automated storage and retrieval system, wherein the automated storage and retrieval system comprises:
a service vehicle according to any one of the preceding claims,
a plurality of goods holders for holding crops, and
a storage section configured to arrange goods holders in a plurality of columns.

An advantage of the automated storage and retrieval system is that no infrastructure of water pipes and/or cables are required for irrigating and/or inspecting the crops while they are stored in the automated storage and retrieval system, i.e. without retrieving the goods holders from their storage spaces.

The automated storage and retrieval system may comprise a control system configured to monitor and control wirelessly movements of the service vehicle.

In one aspect, the automated storage and retrieval system may comprise a rail system, wherein the rail system comprises:
a first set of parallel rails arranged in a horizontal plane and extending in a first direction, and
a second set of parallel rails arranged in the horizontal plane and extending in a second direction which is orthogonal to the first direction,
   which first and second sets of rails form a grid pattern in the horizontal plane comprising a plurality of adjacent cells, each comprising an access opening defined by a pair of neighbouring rails of the first set of rails and a pair of neighbouring rails of the second set of rails.

The service vehicle may be configured for movement on the rail system. The rail system may be arranged above the storage section. A further rail system may be provided below the storage section for remotely operated vehicles to travel along.

In one aspect, the storage section may comprise a plurality of horizontally extending goods holder supporting frameworks distributed with vertical offsets,

wherein the plurality of horizontal goods holder supporting frameworks comprises:
a first goods holder supporting framework, and
at least one second goods holder supporting framework arranged beneath and extending parallel to the first goods holder supporting framework,
   wherein each of the first and the at least one second goods holder supporting frameworks comprises at least one goods holder support,
   wherein each goods holder support comprises a plurality of goods holder storage spaces and displays at least one hole with an opening size being at least a maximum horizontal cross section of the goods holder to be stored, and
   wherein the at least one hole of the first goods holder supporting framework are aligned vertically with the at least one hole of the at least one second goods holder supporting framework, and
   wherein the goods holder supports are horizontally displaceable relative to each other.

An advantage of the plurality of supporting frameworks is that the goods holders stored therein may all be accessible by the yoke without first having to retrieve any one of the other goods holders stored therein.

The yoke may have an area allowing it to enter the at least one hole of the goods holder supports.

Each goods holder supporting framework may comprise a plurality of goods holder supports.

The goods holder storage spaces of the goods holder supports may be arranged in parallel along a first direction X.

The goods holder supports may be configured as a matrix of container spaces with a plurality of columns of container spaces arranged in the first direction X and a plurality of rows of container spaces arranged in the second direction Y.

The goods holder supports may be displaceable in a linear manner or in a rotating manner.

If the goods holder supports are displaceable in a rotating manner, the goods holder storage spaces of the goods holder supports may be distributed in an arc, preferably such that the goods holder storage spaces are circumferentially offset with an equal, or near equal, radial distance from an axis of rotation.

In one aspect, the storage section may comprise:
a plurality of storage towers for storing goods holders and configured for movement in at least one of the first direction and the second direction, and
at least one column void defined by the space between two or more of the plurality of storage towers, the at least one column void having a footprint corresponding to an area of the yoke, and
   wherein the at least one column void can be repositioned within the storage section via movement in at least one of the first direction and the second direction of at least one of the storage towers.

If the automated storage and retrieval system comprises a rail system, the column void may be repositioned into vertical alignment with different access openings of the rail system.

The column void may provide sideways access to the goods holders stored in storage towers adjacent the column void. Sideways access may allow the goods holder to be irrigated and/or inspected by the service vehicle without performing a digging operation.

Each storage tower may comprise a framework of upright members and horizontal supports distributed vertically with vertical offsets for supporting goods holders in storage positions.

Each storage tower may comprise drive means configured to drive the storage tower in at least one of the first direction X and the second direction Y. Alternatively, the system may comprise a displacement device configured to displace the storage tower in at least one of the first direction X and the second direction Y.

The storage towers may be monitored and controlled by the control system.

The storage section may comprise a plurality of stacks of goods holders arranged in storage columns. If the automated storage and retrieval system comprises a rail system, each storage column may be located vertically below an access opening of the rail system.

The storage towers may be configured for movement along the warehouse floor or movement along a rail system arranged below the storage section.

In one aspect, the automated storage and retrieval system may comprise:
a remotely operated vehicle configured to move laterally in the first direction and the second direction above the storage section, wherein the remotely operated vehicle comprises a gripping device configured to grab and lift a goods holder and,
a control system configured to monitor and control wirelessly movements of the remotely operated vehicle.

In one aspect, the storage section may comprise:
a plurality of storage compartments in the form of storage columns provided between upright members, wherein goods holders (e.g. storage containers) are stackable in stacks within the storage columns.

Each storage column may be located vertically below an access opening.

The storage section may comprise any combinations of storage compartments, storage towers, and goods holder supporting frameworks.

The present invention also relates to a method for irrigating crops stored in an automated storage and retrieval system using a service vehicle as described herein,

wherein the method comprises the steps of:
moving the service vehicle to position the yoke above a target column of the storage section, through which target column a target goods holder can be reached,
lowering the yoke to a target depth through the target column,
inspecting and/or irrigating the crop held by the target goods holder, and
raising the yoke to a position above the storage section.

The yoke may be raised and lowered by means of a reel or a lifting device.

The present invention also relates to a method for irrigating crops stored in an automated storage and retrieval system using an automated storage and retrieval system as described herein,

wherein the method comprises the steps of:
moving the remotely operated vehicle to position the gripping device above a target column of the storage section, through which target column a target goods holder can be reached,
retrieving the target goods holder by means of the gripping device,
bringing the remotely operated vehicle and the service vehicle together,
inspecting and/or irrigating crops held by the target goods holder, and
returning the target goods holder to storage in the storage section.

The remotely operated vehicle may preferably bring the target goods holder to the service vehicle. However, the service vehicle may also move towards the remotely operated vehicle.

The service vehicle may be configured to irrigate crops held by a goods holder while the goods holder is being carried by the remotely operated vehicle. The service vehicle may e.g. have a nozzle configured for accessing a goods holder while carried by the remotely operated vehicle. The nozzle may extend or be extendable beyond the vehicle body of the service vehicle.

The service vehicle may be configured to inspect crops held by a goods holder while the goods holder is being carried by the remotely operated vehicle. The service vehicle may e.g. have a camera configured for accessing a goods holder while carried by the remotely operated vehicle. The camera may be arranged on an arm extending or extendable beyond the vehicle body of the service vehicle.

If the remotely operated vehicle (such as a container handling vehicle or a cantilever container handling vehicle e.g. as disclosed in WO2020/094339A1) comprises an aperture, goods holders carried by the remotely operated vehicle may be irrigated and/or inspected through the aperture. If the remotely operated vehicle has a cantilever construction, the aperture may be arranged in the cantilever part.

The remotely operated vehicles may comprise a support surface for supporting a goods holder, wherein a goods holder supported by the support surface is accessible for inspection and/or irrigation by the service vehicle.

The remotely operated vehicle may place the goods holder in an uppermost level of the storage section or on the rail system to give the service vehicle access to the goods holder from above such that irrigation and/or inspection can be performed.

The irrigation of the crops may be adapted based on the findings of the inspection.

In one aspect, the storage section may comprise a plurality of horizontally extending goods holder supporting frameworks distributed with vertical offsets,

wherein the plurality of horizontal goods holder supporting frameworks comprises:
a first goods holder supporting framework, and
at least one second goods holder supporting framework arranged beneath and extending parallel to the first goods holder supporting framework,
   wherein each of the first and the at least one second goods holder supporting frameworks comprises at least one goods holder support,
   wherein each goods holder support comprises a plurality of goods holder storage spaces and displays at least one hole with an opening size being at least a maximum horizontal cross section of the goods holder to be stored, and
   wherein the at least one hole of the first goods holder supporting framework are aligned vertically with the at least one hole of the at least one second goods holder supporting framework, and
   wherein the goods holder supports are horizontally displaceable relative to each other,
   wherein the method may further comprise the steps of:
where necessary, displacing the goods holder support on which the target goods holder is supported to position the target goods holder in vertical alignment with the target column, and
where necessary, and if the goods holder support on which the target goods holder is supported is not the uppermost goods holder support, displacing the above goods holder support, or each of the above goods holder supports, to position the at least one hole in vertical alignment with the target column.

In one aspect, the storage section may comprise:
a plurality of storage towers for storing goods holders and configured for movement in at least one of the first direction and the second direction, and
at least one column void defined by the space between two or more of the plurality of storage towers, the at least one column void having a footprint corresponding to an area of the yoke, and
   wherein the at least one column void can be repositioned within the storage section via movement in at least one of the first direction and the second direction of at least one of the storage towers,
   wherein the method further comprises the step of:
moving one or several storage towers in a first direction and/or a second direction to reposition the at least one column void into vertical alignment with the target column and adjacent the storage tower in which a target goods holder is stored.

In one aspect, any one of the above-mentioned methods may comprise the initial step of:
purging the line(s) of the reel.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of a service vehicle comprising a yoke and a reel, and being suitable for irrigation and/or inspection of crops stored within an automated storage and retrieval system;

FIG. 6 is a perspective view of the service vehicle operating in an automated storage and retrieval system and lowering the yoke into a storage section of the automated storage and retrieval system by means of the reel;

FIG. 7 is a perspective view of the service vehicle operating in an automated storage and retrieval system having retrieved the yoke above the storage section storing a plurality of goods holders for holding crops;

FIG. 8 is a perspective view of a service vehicle being suitable for irrigation and/or inspection of crops stored within an automated storage and retrieval system;

FIG. 9 is a perspective view of the service vehicle operating in an automated storage and retrieval system;

FIG. 10 is a side view of the service vehicle operating in an automated storage and retrieval system, wherein the storage section of the automated storage and retrieval system comprises a plurality of horizontally extending goods holder supporting frameworks distributed with vertical offsets;

FIG. 11 is a side view of the service vehicle of FIG. 10, wherein the service vehicle is aligned with a below target goods holder, and the intermediate horizontally extending goods holder supporting frameworks have been displaced to make the target goods holder accessible to the service vehicle;

FIG. 12 is a side view of the service vehicle of FIG. 11, wherein the service vehicle has lowered the yoke through the holes in the intermediate horizontally extending goods holder supporting frameworks to reach the target goods holder; and

FIG. 13 is a cross-sectional side view of a service vehicle of FIG. 13, wherein the service vehicle is inspecting and irrigating crops held in the target goods holder without retrieving the goods holder.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

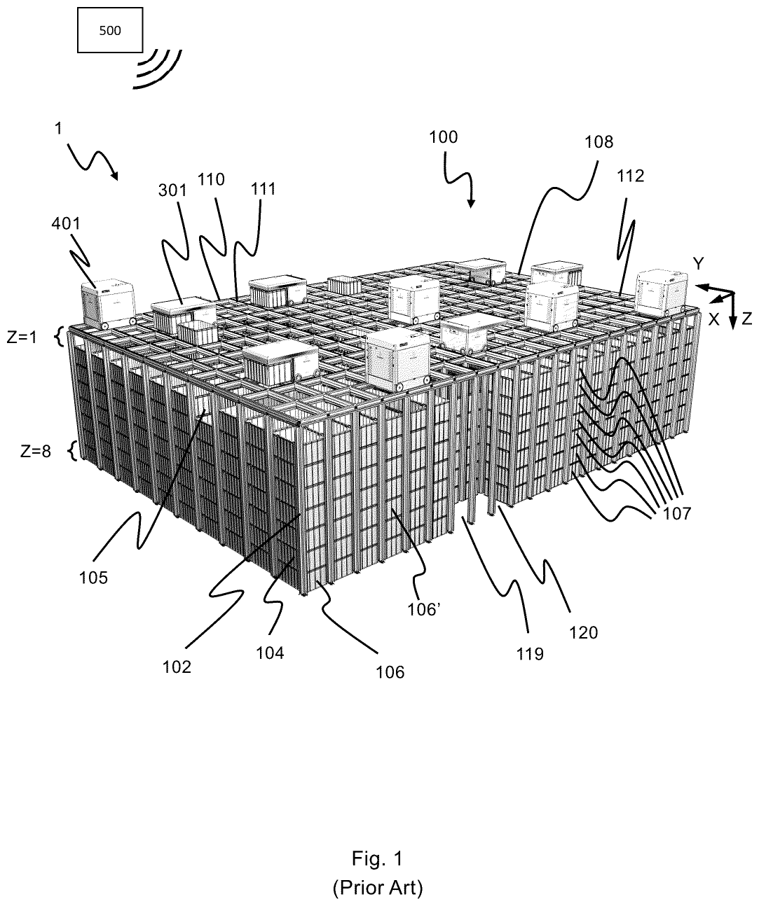

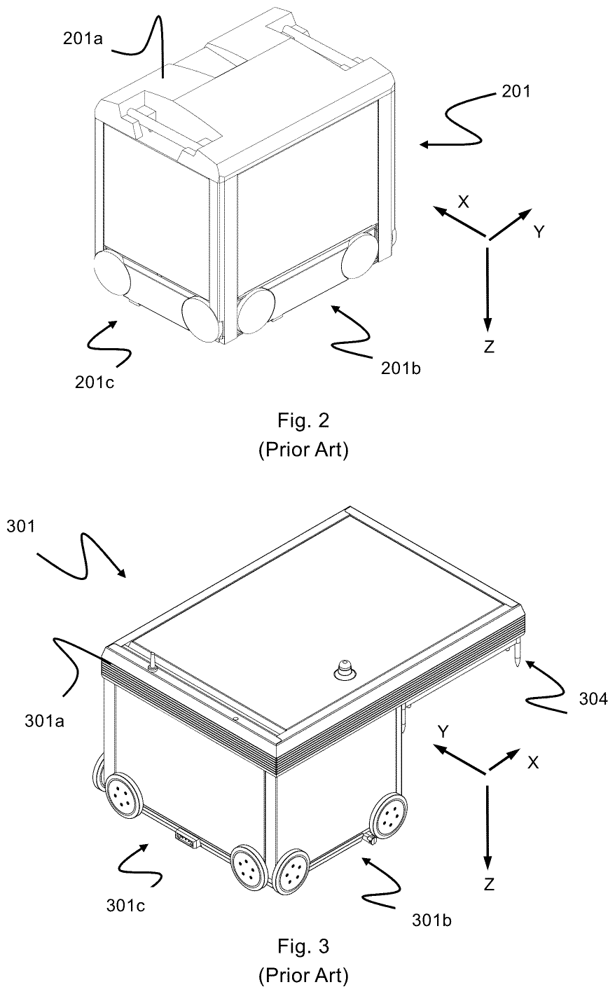

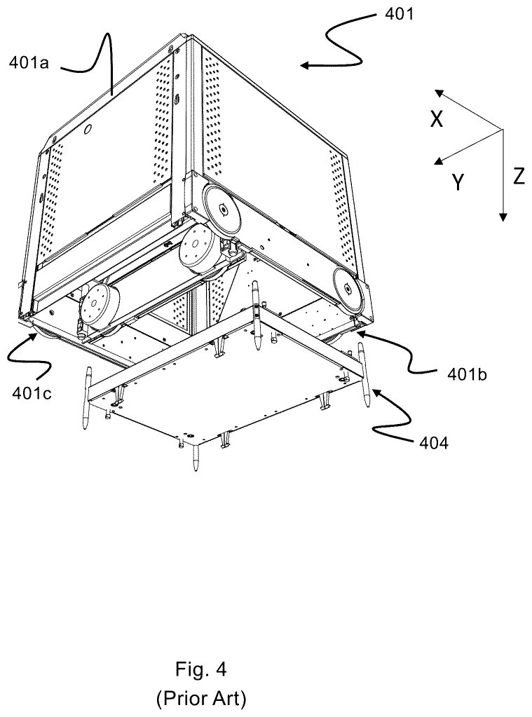

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

One embodiment of the automated storage and retrieval system according to the invention will now be discussed in more detail with reference to Figs.

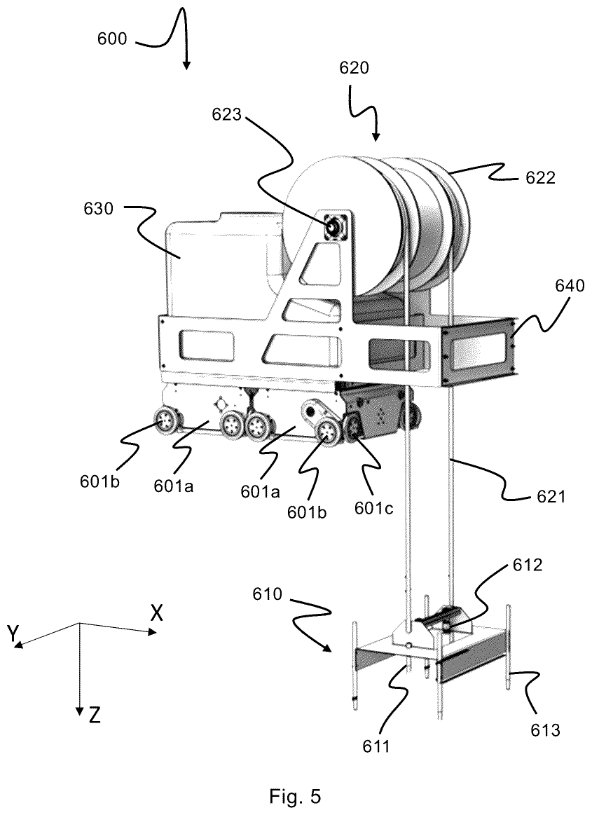

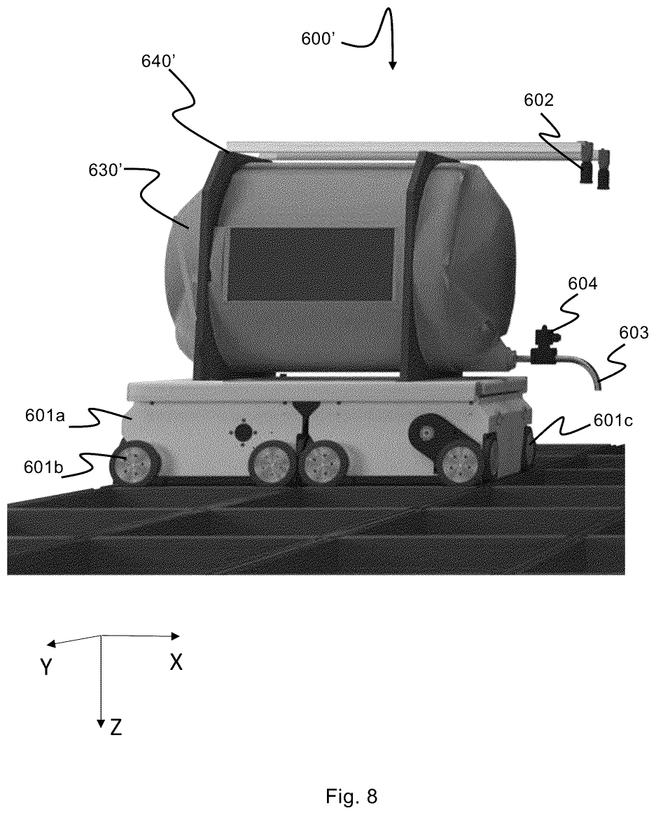

FIG. 5 and FIG. 8 are perspective views of service vehicles 600;600′ configured to operate in an automated storage and retrieval system. The automated storage and retrieval system can be used for vertical farming and then typically comprise a plurality of goods holders for holding crops 750. The goods holders can preferably be stored in stacked or non-stacked columns in a storage section 700 of the automated storage and retrieval system. The stacked or non-stacked columns are typically vertically oriented.

The service vehicles 600;600′ both comprise a first set of wheels 601b and a second set of wheels 601c for moving the service vehicles 600;600′ along a rail system 708 arranged above the storage section 700 of the automated storage and retrieval system.

The service vehicles 600;600′ of FIG. 5 and FIG. 8 each comprise two vehicle bodies 601a arranged side-by-side. The first set of wheels 601b and the second set of wheels 106c are arranged on the vehicle bodies 601a.

The first set of wheels 601b and the second set of wheels 601c may each comprise eight wheels. If the service vehicle 600;600′ comprises two or more vehicle bodies 601a, the number of wheels may be evenly distributed on the vehicle bodies 601a.

The first set of wheels 601b may comprise a higher or lower number of wheels than the second set of wheels 601c.

The service vehicles 600;600′ of FIG. 5 and FIG. 8 comprise irrigation equipment for irrigating crops 750 held by a goods holder of the automated storage and retrieval system. The service vehicles 600;600′ also comprise inspection equipment for inspecting crops 750 held by a goods holder of the automated storage and retrieval system. By comprising both inspection equipment and irrigation equipment the service vehicles 600;600′ may inspect the crops held in a target goods holder prior to the irrigation in order to verify that the crops 750 actually need to be irrigated. Alternatively, a first service vehicle may only comprise irrigation equipment. In such a case the automated storage and retrieval system may preferably also comprise a second service vehicle comprising inspection equipment. A service vehicle only comprising irrigation equipment may be set up to irrigate crops at given intervals without performing an inspection prior to irrigating. The automated storage and retrieval system may comprise several service vehicles of any type (i.e. comprising irrigation equipment, comprising inspection equipment, or comprising both inspection and irrigation equipment).

The irrigation equipment typically comprise a water tank 630;630′ and a nozzle 611;603 arranged in fluid communication with the water tank 630;630′. As illustrated in FIG. 5, the nozzle 611 can be connected to the water tank 630 by means of a line 621, such as a hose or an umbilical. The water tank 630;630′ is typically arranged on the vehicle body/bodies 601a of the service vehicle 600;600′. In FIG. 8 it is illustrated that a nozzle 603 alternatively may be connected directly to the water tank 630′.

Additionally, the irrigation equipment may comprise a valve 604 arranged upstream the nozzle 603 and configured to shut off the water flow from the water tank 630′ to the nozzle 603.

The inspection equipment typically comprises a camera 602,612 for visual inspection of the crops 750. The inspection equipment can additionally comprise a light source, one or several sensors, and a sampling unit.

In FIG. 5, the service vehicle 600 comprises a yoke 610 configured for holding the irrigation equipment and the inspection equipment. The inspection equipment in the form of a camera 612 is arranged on the yoke 610 in a downwardly directed manner such that crops 750 held in a goods holder positioned below the yoke 610 can be inspected. The irrigation equipment in the form of a nozzle 611 is arranged on the yoke 610 in a downwardly directed manner such that crops 750 held in a target goods holder positioned below the yoke 610 can be irrigated. The water tank 630 can alternatively be arranged on the yoke 610 instead of the vehicle bodies 601a. However, vehicle bodies 601a will normally be suitable for carrying a larger water tank 630 than the yoke 610.

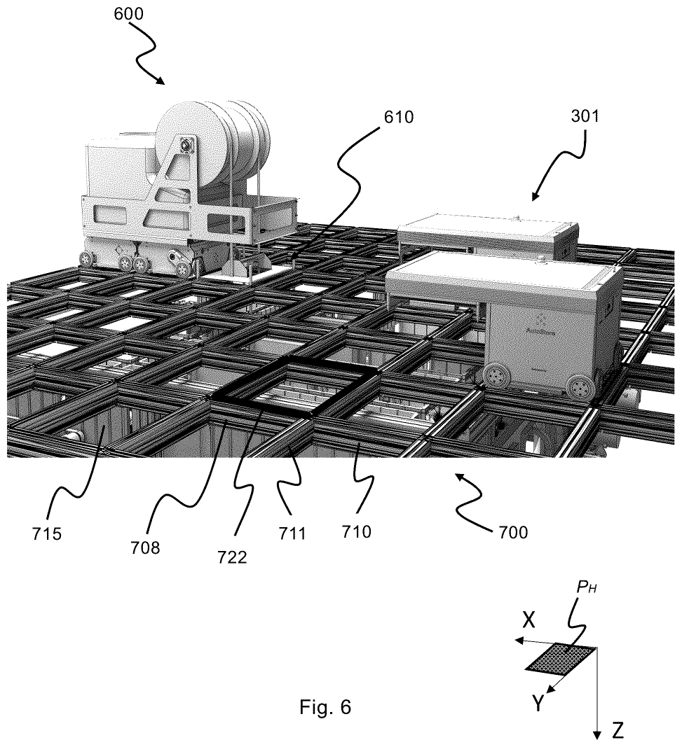

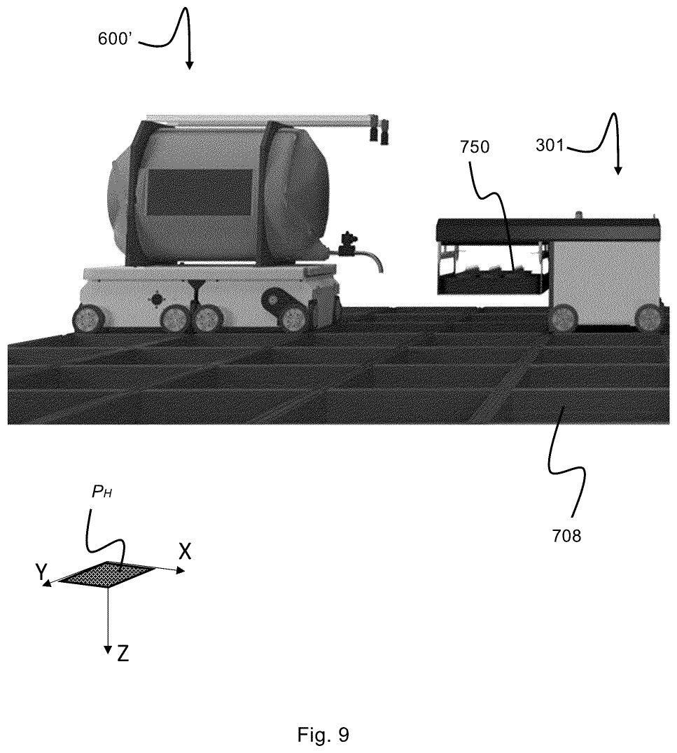

The target goods holder may be located in the storage section 700 of the automated storage and retrieval system while being inspected and/or irrigated, as illustrated in FIG. 6. Alternatively, the target goods holder may be carried by a cantilever container handling vehicle 301 while being inspected and/or irrigated, as illustrated in FIG. 9.

The yoke 610 illustrated in FIG. 5 may comprise a guiding device 613 configured for guiding the yoke 610 in the storage section 700 in the form of vertically extending guide pins arranged in the corners of the yoke 610 and/or guide plates arranged along the periphery of the yoke 610.

The service vehicle 600 comprises a reel 620 connected to the yoke 610. The reel 620 is configured for lowering and raising the yoke 610 into and out of the storage section 700 such that the yoke 610 can reach goods holders stored in the automated storage and retrieval system.

By raising the yoke 610 above the storage section 700, the yoke 610 may reach a goods holder carried by a cantilever container handling vehicle 301.

As illustrated in FIG. 5, the reel 620 may comprise a drum 622 and two lines 621 coiled onto the drum 622. The lines 621 may be coiled in a manner causing them to uncoil in response to rotation of the drum 622 in a first direction, and causing them to coil up in response to a rotation of the drum 622 in a second direction opposite the first direction. By means of the uncoiling, the yoke 610 can be lowered. By means of the coiling up, the yoked 610 can be raised.

The service vehicle 600 of FIG. 5 comprises a frame 640 configured to hold the reel 620 in a manner allowing it to rotate freely. The reel 620 may further comprise a motor 623 configured to apply rotational drive to the drum 622 such that the yoke 610 can be raised or lowered. The motor 623 may be connected to the frame 640.

The reel 620 is arranged such that the lines 621 and the yoke 610 can be raised and lowered without interfering with the vehicle bodies 601a.

When a plurality of lines 621 are coiled onto the drum 622, the lines 621 may be spaced apart.

In FIG. 5, the water tank 630 has a flat bottom surface resting on the vehicle bodies 601a. The frame 640 surrounding the water tank 630 extends a certain height from the vehicle bodies 601a such that the water tank 630 can be held in place on the vehicle bodies 601a.

In FIG. 8, the water tank 630′ is cylinder-shaped and arranged with its axial direction horizontally oriented. The frame 640′ surrounding the water tank 630′ has a flat bottom surface resting on the vehicle bodies 601a.

The frame 640 illustrated in FIG. 5 comprises a cantilever part extending beyond the footprint of the vehicle bodies 601a and is arranged below the reel 620. The cantilever part may have an opening configured for receiving the yoke 610 and keeping the yoke 610 steady when the service vehicle 600 is moving. The yoke 610 can then be lowered into the storage section 700 immediately after the service vehicle 600 has come to a standstill, as the cantilever part of the frame 640 can prevent the yoke 610 from swinging.

The frame 640′ illustrated in FIG. 8 comprises a cantilever part extending beyond the footprint of the vehicle bodies 601a and is arranged above the nozzle 603. Inspection equipment at least in the form of a camera 602 can be arranged on the cantilever part of the frame 640′.

The frames 640;640′ illustrated in FIG. 5 and FIG. 8 are arranged on both vehicle bodies 601a of the service vehicles 600;600′.

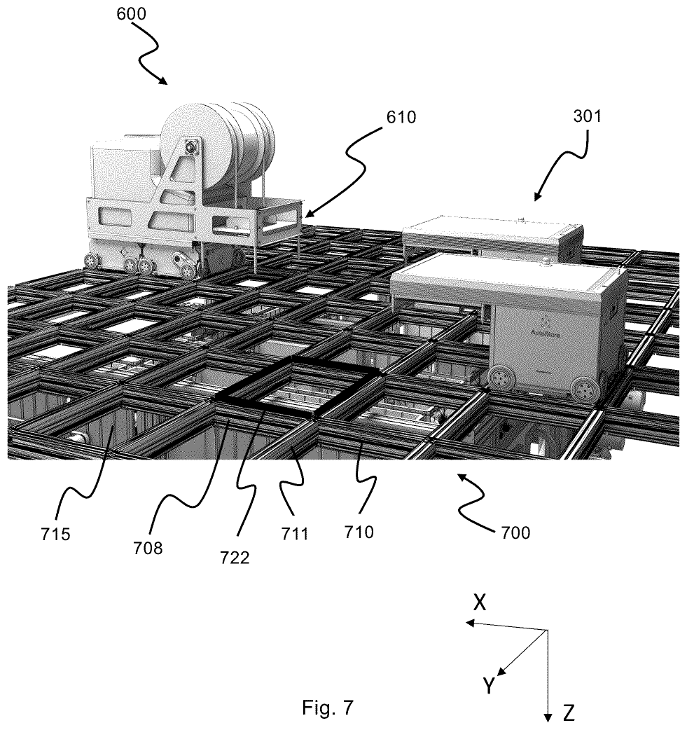

FIG. 6, FIG. 7, and FIG. 9 show perspective views of automated storage and retrieval systems, each comprising a service vehicle 600;600′ as described herein. Each of the automated storage and retrieval systems further comprise a plurality of goods holders for holding crops 750, and a storage section 700 configured to arrange the goods holders in a plurality of columns. Furthermore, each automated storage and retrieval system comprises a rail system 708.

The rail system 708 comprises a first set of parallel rails 710 arranged in a horizontal plane P_{H} and extending in a first direction X, and a second set of parallel rails 711 arranged in the horizontal plane P_{H} and extending in a second direction Y which is orthogonal to the first direction X.

The first set of rails 710 and the second set of rails 711 form a grid pattern in the horizontal plane P_{H} comprising a plurality of adjacent cells 722, each comprising an access opening 715 defined by a pair of neighbouring rails of the first set of rails 710 and a pair of neighbouring rails of the second set of rails 711.

Each automated storage and retrieval system may further comprise a plurality of remotely operated vehicles, such as cantilever container handling vehicles 301, configured to move laterally in the first direction X and the second direction Y above the storage section 700. The container handling vehicles 301 comprise a gripping device 304 configured to grab and lift a goods holder.

Each automated storage and retrieval system may further comprise a control system 500 configured to monitor and control wirelessly movements of the cantilever container handling vehicle 301.

In FIG. 6, the service vehicle 600 has lowered its yoke 610 through an access opening 715 of the rail system 708 to access a goods holder stored in the storage section 700.

In FIG. 7, the service vehicle 600 has raised its yoke 610 above the rail system 708 and is thus free to relocate on the rail system 708 in order to access another goods holder stored in the storage section 700. Alternatively, the service vehicle 600 can access a goods holder carried by a container handling vehicle 301;401 of the automated storage and retrieval system.

In FIG. 9, the service vehicle 600′ is aligned with a cantilever container handling vehicle 301 in the first direction X. The service vehicle 600′ and the cantilever container handling vehicle 301 are facing each other. The service vehicle 600′ can thus engage the cantilever container handling vehicle 301 to inspect and/or irrigate the crops 750 arranged in the goods holder carried by the cantilever container handling vehicle 301.

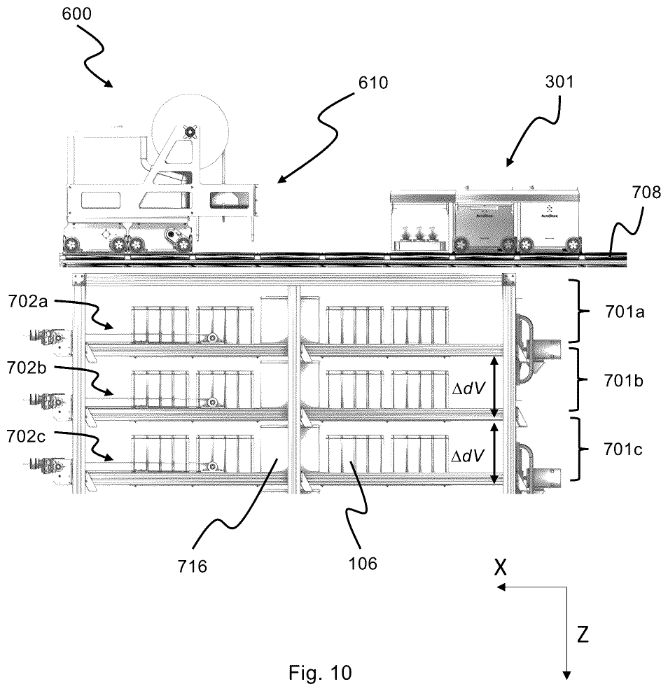

FIG. 10 shows a section of a side view of the service vehicle 600 as described herein operating in an automated storage and retrieval system. The storage section 700 of the automated storage and retrieval system comprises a plurality of horizontally extending goods holder supporting frameworks 701 distributed with vertical offsets ΔdV.

The plurality of horizontal goods holder supporting frameworks 701 comprises a first goods holder supporting framework 701a, and a plurality of second goods holder supporting frameworks 701b-c arranged beneath and extending parallel to the first goods holder supporting framework 701a. Each of the goods holder supporting frameworks 701a-c comprises at least one goods holder support 702. And each goods holder support 702 comprises a plurality of goods holder storage spaces 704 and displays at least one hole 703 with an opening size being at least a maximum horizontal cross section of the goods holders to be stored. Furthermore, each goods holder support 702 may be horizontally displaceable by means of a displacement device 705.

In FIG. 10, the goods holders are stored in non-stacked columns in the storage section 700 of the automated storage and retrieval system.

By means of being displaceable and comprising at least one hole 703, the goods holder supports 702 may be configured such that all goods holders stored therein can be accessible without having to retrieve anyone of the other goods holders. Depending on the type of service vehicle 600, the irrigation and/or inspection may take place at the goods holder storage space 704, or the goods holder may be retrieved from the goods holder storage space 704 before being irrigated and/or inspected.

In FIG. 10, the at least one hole 703 of the first goods holder supporting framework 701a is aligned vertically with the at least one hole 703 of each one of the second goods holder supporting frameworks 701b-c. This may be set as a default arrangement of the goods holder supports 702.

In FIG. 10 only two second goods holder supporting frameworks 701b,701c are illustrated. However, a higher number of second goods holder supporting frameworks can be envisaged.

In FIG. 10, each goods holder support 702a-c is displaceable a distance approximately corresponding to two goods holder storage spaces 704. However, goods holder supports 702 being displaceable a longer or a shorter distance can be envisaged, e.g. distances corresponding to one or three goods holder storage spaces 704.

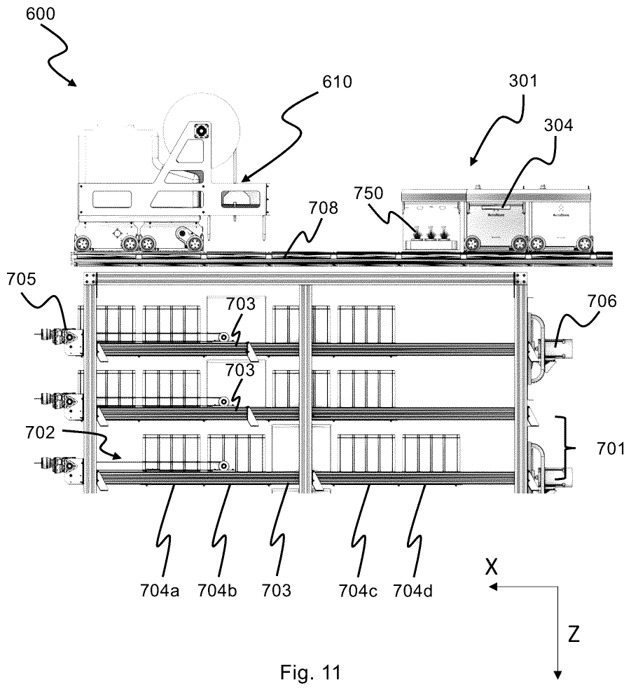

FIG. 11 shows a side view of the service vehicle 600 and the automated storage and retrieval system of FIG. 10. In FIG. 11, the service vehicle 600 has been moved along the rail system 708 to position the yoke 610 above a target goods holder. The target goods holder is stored on the lowermost goods holder support 702c illustrated in the figure, and in particular on a second goods holder storage space 704b thereof.

The goods holder supports 702a-b arranged above the lowermost goods holder support 702c (i.e. the two uppermost goods holder supports 702 illustrated in the figure) have been displaced a distance corresponding to one storage space 704 to the left in FIG. 11. In this way the holes 703 of the two uppermost goods holder supports 702a-b are vertically aligned with the target goods holder and thus forms a void in the target column in the storage section 700, through which the target goods holder can be reached by the yoke 610.

As an alternative to displacing the two uppermost goods holder supports 702a-b and not displacing the lowermost goods holder support 702c, the lowermost goods holder support 702c could have been displaced in the opposite direction (i.e. to the right in the figure) while not displacing the two uppermost goods holder supports 702a-b. The target goods holder would then also be made accessible to the yoke 610, although the target column would be arranged below a different access opening 715 in the rail system 708.

If the target goods holder is stored on the first goods holder storage space 704a, all the goods holder supports 702a-c are displaced to make the target goods holder accessible to the yoke 610. In particular, the uppermost goods holder supports 702a-b are displaced to the left in the figure and the lowermost goods holder support 702c is displaced to the right in the figure (i.e. the two uppermost goods holder supports 702a-b displaced in the opposite direction as the lowermost goods holder support 702c).

If the target goods holder was stored in the uppermost goods holder support 702a, no displacement of goods holder supports 702 would be required and the target goods holder could be accessed by the yoke 610 through an above access opening 715.

Once the target goods holder is made accessible and the service vehicle 600 has positioned the yoke 610 in vertical alignment with the target goods holder, the yoke 610 can be lowered to a target depth in the target column by means of the reel 620.

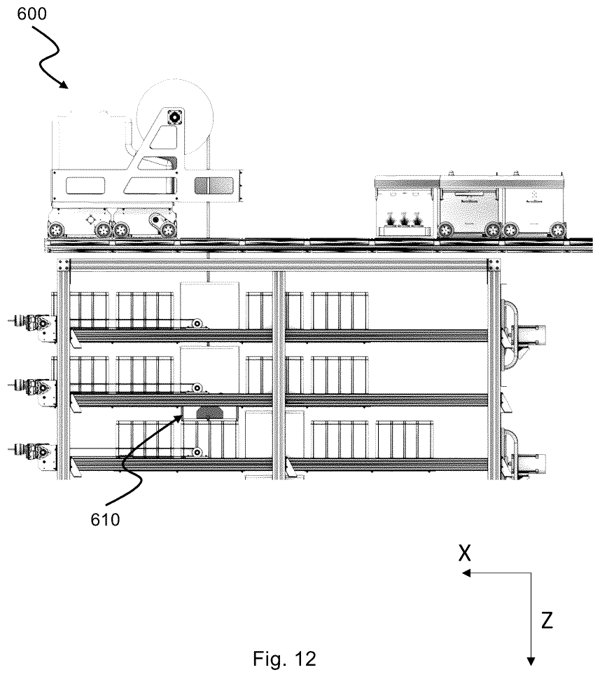

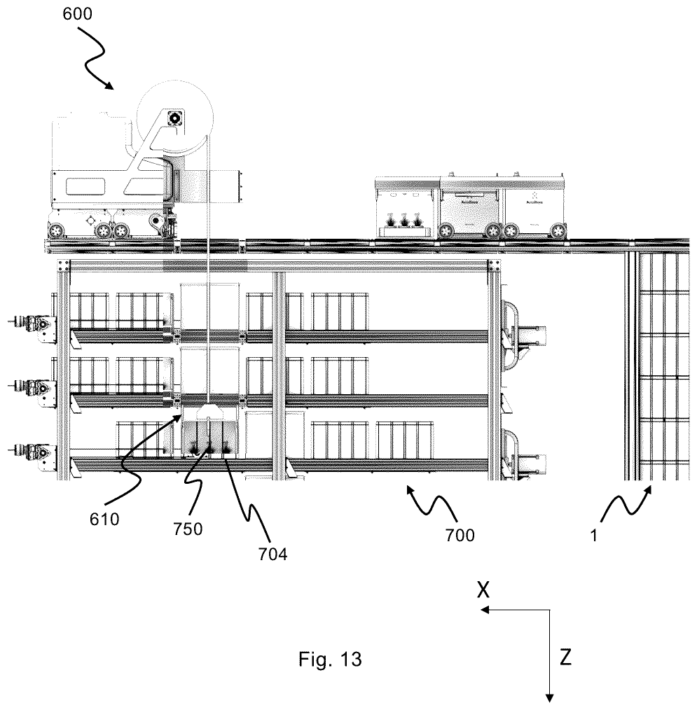

In FIG. 12, the yoke 610 has been lowered into the storage section 700 to a depth directly above the target goods holder. The service vehicle 600 may then inspect and/or irrigate the crops 750 held by the target goods holder, as illustrated in FIG. 13. After inspection and/or irrigation of the crops 750, the yoke 610 can be raised to a position above the storage section 700 by means of the reel 620.

In FIG. 11, the service vehicle 600 may be moved and the cantilever container handling vehicle 301 may be moved to position the gripping device 304 above the target column of the storage section 700, through which target column the target goods holder can be reached. The target goods holder may then be retrieved by means of the gripping device 304. The service vehicle 600 and the cantilever container handling vehicle 301 may then be brought together such that the service vehicle 600 can inspect and/or irrigate the crops 750 of the target goods holder carried by the cantilever container handling vehicle 301. After inspection and/or irrigation of the crops 750 in the target goods holder, the cantilever container handling vehicle 301 may return the target goods holder to storage in the storage section 700.

In FIG. 10, it is illustrated how one or several plates 716 may be arranged around the periphery of the at least one hole 703 provided in each goods holder support 702. The plates can guide the yoke 610 as it is raised and lowered in the storage section 700.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
100 Framework structure
102 Upright members of framework structure
104 Storage grid
105 Storage column
106 Storage container
106′ Particular position of storage container
107 Stack
108 Rail system
110 Parallel rails in first direction (X)
112 Access opening
119 First port column
120 Second port column
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
500 Control system
600, 600′ Service vehicle
601a Vehicle body of the service vehicle
601b Drive means/first set of wheels in first direction (X)
601c Drive means/second set of wheels in second direction (Y)
602 Camera
603 Nozzle
604 Valve
610 Yoke
611 Nozzle on the yoke
612 Camera on the yoke
613 Guiding device on the yoke
620 Reel
621 Line
622 Drum
623 Motor
630, 630′ Water tank
640, 640′ Frame
700 Storage section
701, 701a-c Horizontal goods holder supporting framework
702, 702a-c Goods holder supports
703 Hole
704, 704a-d Goods holder storage space
705 Displacement device
706 Fan
708 Rail system
710 First set of parallel rails
711 Second set of parallel rails
715 Access opening
716 Plate
722 Cell
750 Crop
X First direction
Y Second direction
Z Third direction
P_{H} Horizontal plane
ΔdV Vertical offset

1. A service vehicle for irrigation and/or inspection of crops stored within an automated storage and retrieval system,
wherein the automated storage and retrieval system comprises:
a plurality of goods holders for holding crops,
a storage section configured for storing goods holders in a plurality of columns,
wherein the service vehicle is movable above the storage section and comprises:
irrigation equipment for irrigating crops held by a goods holder, and/or
inspection equipment for inspecting crops held by a goods holder.

2. The service vehicle according to claim 1,
wherein the service vehicle comprises:
a yoke configured for holding irrigation and/or inspection equipment.

3. The service vehicle according to claim 2,
wherein the service vehicle comprises:
a reel configured for lowering and raising the yoke into and out of the storage section.

4. The service vehicle according to claim 1, wherein the irrigation equipment comprises:
a water tank, and
a nozzle in fluid communication with the water tank.

5. The service vehicle according to claim 1, wherein the inspection equipment comprises a camera.

6. The service vehicle according to claim 3, wherein the reel comprises one or more lines.

7. The service vehicle according to claim 2, wherein the yoke comprises a guiding device configured for guiding the yoke in the storage section.

8. The service vehicle according to claim 1, wherein the service vehicle comprises a first set of wheels and a second set of wheels for moving the service vehicle along a rail system arranged above the storage section of the automated storage and retrieval system.

9. An automated storage and retrieval system, wherein the automated storage and retrieval system comprises:
a service vehicle according to claim 1,
a plurality of goods holders for holding crops, and
a storage section configured to arrange the plurality of goods holders in a plurality of columns.

10. The automated storage and retrieval system according to claim 9, wherein the automated storage and retrieval system comprises a rail system, wherein the rail system comprises:
a first set of parallel rails extending in a first direction, and
a second set of parallel rails and extending in a second direction perpendicular to the first direction.

11. The automated storage and retrieval system according to claim 9, wherein the storage section comprises a plurality of horizontally extending goods holder supporting frameworks distributed with vertical offsets,
wherein the plurality of horizontal goods holder supporting frameworks comprises:
a first goods holder supporting framework, and
at least one second goods holder supporting framework arranged beneath and extending parallel to the first goods holder supporting framework,
wherein each of the first and the at least one second goods holder supporting frameworks comprises at least one goods holder support.

12. The automated storage and retrieval system according to claim 9, wherein the storage section comprises;
a plurality of storage towers for storing goods holders and configured for movement in at least one of the first direction and the second direction, and
at least one column void defined by the space between two or more of the plurality of storage towers, the at least one column void having a footprint corresponding to an area of a yoke, and
wherein the at least one column void can be repositioned within the storage section via movement in at least one of the first direction and the second direction of at least one of the storage towers.

13. The automated storage and retrieval system according to claim 9, wherein the automated storage and retrieval system comprises:
a remotely operated vehicle configured to move laterally in the first direction and the second direction above the storage section, wherein the remotely operated vehicle comprises a gripping device configured to grab and lift a goods holder and,
a control system configured to monitor and control wirelessly the remotely operated vehicle.

14. A method for inspecting and/or irrigating crops stored in an automated storage and retrieval system using a service vehicle according to claim 2,
wherein the method comprises:
moving the service vehicle to position a yoke above a target column of the storage section, through which target column a target goods holder can be reached,
lowering the yoke to a target depth through the target column, and
inspecting and/or irrigating the crop held by the target goods holder.

15. A method for inspecting and/or irrigating crops stored in an automated storage and retrieval system using an automated storage and retrieval system according to claim 13,
wherein the method comprises:
moving the remotely operated vehicle to position the gripping device above a target column of the storage section, through which target column a target goods holder can be reached,
retrieving the target goods holder by means of the gripping device,
bringing the remotely operated vehicle and the service vehicle together, and
inspecting and/or irrigating crops held by the target goods holder.

16. The method according to claim 14,
wherein the storage section comprises a plurality of horizontally extending goods holder supporting frameworks distributed with vertical offsets,
wherein the plurality of horizontal goods holder supporting frameworks comprises:
a first goods holder supporting framework and
at least one second goods holder supporting framework arranged beneath and extending parallel to the first goods holder supporting framework,
wherein each of the first and the at least one second goods holder supporting frameworks comprises at least one goods holder support,
wherein each goods holder support comprises a plurality of goods holder storage spaces and displays at least one hole with an opening size being at least a maximum horizontal cross section of the goods holder to be stored, and
wherein the at least one hole of the first goods holder supporting framework are aligned vertically with the at least one hole of the at least one second goods holder supporting framework, and
wherein the goods holder supports are horizontally displaceable relative to each other,
wherein the method further comprises:
where necessary, displacing the goods holder support on which the target goods holder is supported to position the target goods holder in vertical alignment with the target column.

17. The method according to claim 14,
wherein the storage section comprises:
a plurality of storage towers for storing goods holders and configured for movement in at least one of the first direction and the second direction, and
at least one column void defined by the space between two or more of the plurality of storage towers, the at least one column void having a footprint corresponding to an area of a yoke, and
wherein the at least one column void can be repositioned within the storage section via movement in at least one of the first direction and the second direction of at least one of the storage towers,
wherein the method further comprises:
moving one or several storage towers in a first direction and/or a second direction to reposition the at least one column void into vertical alignment with the target column and adjacent the storage tower in which a target goods holder is stored.

18. The automated storage and retrieval system according to claim 11,
wherein each goods holder support comprises a plurality of goods holder storage spaces and displays at least one hole with an opening size being at least a maximum horizontal cross section of the goods holder to be stored, and
wherein the at least one hole of the first goods holder supporting framework is aligned vertically with the at least one hole of the at least one second goods holder supporting framework.

19. The automated storage and retrieval system according to claim 11,
wherein the goods holder supports are horizontally displaceable relative to each other.

20. The method of claim 16 further comprising:
where necessary, and if the goods holder support on which the target goods holder is supported is not the uppermost goods holder support, displacing the above goods holder support, or each of the above goods holder supports, to position the at least one hole in vertical alignment with the target column.
